(19) United States
(12) Patent Application Publication
(10) Pub. No.: US 2005/0258920 A1
(43) Pub. Date: Nov. 24, 2005

(54) System and method for launching surface waves over unconditioned lines

(76) Inventor: Glenn E. Elmore, Santa Rosa, CA (US)

Correspondence Address: JOHNSON & STAINBROOK, LLP, 3558 ROUND BARN BLVD., SUITE 203, SANTA ROSA, CA, 95403, US

(21) Appl. No.: 11/134,016

(22) Filed: May 20, 2005

Related U.S. Application Data
(60) Provisional application No. 60/573,531, filed on May 21, 2004.
(60) Provisional application No. 60/576,354, filed on Jun. 1, 2004.

(51) Int. Cl. H01P 3/10

(52) U.S. Cl. 333/240

(57) ABSTRACT

A low loss transmission system which utilizes a single uninsulated central conducting line segment without any special surface treatment or special enclosing dielectric and having launch devices mounted at each end. The invention provides the use of conductors with circumference approaching and exceeding one wavelength at the propagating frequency. In combination, this invention enables the use of unconditioned and uninsulated conductors and in particular, existing overhead electric power lines which are available worldwide, for the economic and efficient transport of information.

### CROSS REFERENCE TO RELATED APPLICATIONS

The present application claims the benefit of the filing date of U.S. Provisional Patent Application, Ser. No. 60/573,531, filed 21 May 2004, and U.S. Provisional Patent Application, Ser. No. 60/576,354, filed 1 Jun. 2004.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to surface wave transmission systems, and more particularly to an improved low loss system for launching surface waves over unconditioned lines such as power lines.

### BACKGROUND INFORMATION AND DISCUSSION OF RELATED ART

The prior art in the field of surface wave transmission over single conductor transmission lines has failed to properly recognize the potential for using conductors which are unconditioned, that is, having no special surface treatment or modification and without any dielectric (insulating) sheath. Because the most thorough prior art taught directly against it, the opportunity to use the large existing worldwide infrastructure of overhead electric power lines for the transport of information has not previously been understood or appreciated. This present invention discloses a novel use of surface waves on unconditioned lines to provide an extremely practical, economic and very high capacity information transmission system.

References 1 and 2, cited below, and Goubau U.S. Pat. No. 2,685,068 disclose a transmission line in which energy is propagated by electromagnetic waves and guided along the outer surface of an elongated conductor, such as a wire, wherein that conductor has its outer surface conditioned, or modified, so as to reduce the phase velocity of the transmitted energy to thereby concentrate the field of the transmitted wave adjacent the conductor. Also presented was a launching device for exciting surface waves for transmission along the line, wherein the launching device has an aperture diameter of at least one wave length. The resulting transmission system was presented as having extremely low attenuation and very high bandwidth, being capable of supporting frequencies from 50 MHz into the region of at least several Ghz.

At the core of Goubau's accompanying description and theory is the development that the above reduction in phase velocity by special modification or conditioning of the conductors surface is essential to the surface wave mode being contained in the region close to the conductor and also essential to the wave not radiating away from the conductor. Theory was presented indicating the nature of the special conditioning, particularly including the addition of a dielectric sheath around the conductor, which was considered necessary to achieve the preferred qualities indicated for this invention, including low transmission and radiation losses. A significant part of the background includes theory with respect to the power transmitted through, and the losses sustained within, the dielectric material. As an alternative to a surface coating or sheath, modifications to the line are detailed in the form of external threads, projections and depressions, roughness or twisting of multiple conductors, along the length of the line which are deemed necessary to provide the same slowing of the wave on the surface of the conductor.

Goubau taught directly against the use of conductor having no special conditioning. In the background information he describes the potential use of his invention with unmodified conductors and states: “Adequate, but less efficient, results for some purposes may be obtained by using a bare, unmodified wire in combination with the launching horn shown in FIGS. 8 and 9. Actually even for a bare conductor there is a microscopically thin dielectric layer present on its surface which tends to concentrate adjacent the conductor the field of the transmitted energy. For frequencies below about 5000 megacycles per second this minute surface layer is insufficient to shrink the radial extent of the field enough to permit the use of a bare conductor with a horn of convenient dimensions. However, at higher frequencies the required thickness of dielectric layer to accomplish a given amount of field concentration is lessened, and use of a bare conductor in combination with a conical horn is feasible. It will be understood that, for any given frequency of the transmitted energy, a considerably larger horn diameter will be required for a bare conductor than for a conductor with modified surface. This is because the shrinkage of the radial extent of the field depends upon the thickness of the dielectric layer on the conductor surface.”

“FIG. 20 shows how the field decreases with the distance from the wire. The ratio of the magnetic field strength at a distance from the wire to the magnetic field strength at the surface of the wire is plotted versus the distance from the wire, measured in multiples of the wire radius. Both scales are logarithmic. The dashed line indicates a decrease which would be present in the case of an uncoated wire with infinite conductivity. In this case, the phase velocity would be equal to the velocity of light, and, as previously mentioned, the power would be infinite if the field strength were finite. The solid line curves show how the field decreases if the phase velocity is reduced by 1%, 5% and 10%. Immediately adjacent the wire these curves follow the decrease, and at larger distances approach an exponential decrease. The more the phase velocity is reduced, the earlier the exponential decrease begins.” (Goubau U.S. Pat. No. 2,605,068, column 19, lines 10-64).

These statements in conjunction with the complete exclusion of “unmodified” conductors from all of the patent claims make clear that the value, utility and potential for such implementations was not appreciated by that inventor.

Although Goubau's invention has since been taught in engineering schools, available in reference texts and seen some utility in special cases, a widespread deployment or extensive commercial use of this invention has not yet been seen.

References for the foregoing background discussion include:
[1] G. Goubau, “Surface waves and their applications to transmission lines,” J. Appl. Phys., vol. 21, p. 1119, 1950.
[2] G. Goubau, “Single-conductor surface-wave transmission lines,” Proc. IRE, vol. 39, pp. 619624, June 1951.

[3] A. F. Harvey, Microwave Engineering. New York: Academic, 1963.
[4] J. A. Stratton, Electromagnetic Theory. New York: McGraw-Hill, 1941, p. 527.
[5] H. F. M. Barlow and A. L. Cullen, “Surface waves,” Proc. Inst. Elect. Eng., vol. 100, pp. 329-427, November 1953.
[6] F. J. Zucker, “Theory and applications of surface waves,” Nuvo Cimento 9 Sup., vol. 3, pp. 450-472, 1952.
[7] W. Rotman, “A study of single-surface corrugated guides,” Proc. IRE, vol. 39, pp. 952-959, August 1951.
[8] S. S. Attwood, “Surface-wave propagation over a coated plane conductor,” J. Appl. Phys., vol. 22, pp. 504-509, April 1951.
[9] G. Goubau, & E. Sharp “Investigations with a Model Surface Wave Transmission Line” IRE Transactions on Antennas and Propagation, pp 222-227, April 1957.
[10] Georg Goubau, “Open Wire Lines” IRE Transactions on Microwave Theory and Techniques, pp 197-200, October 1956.
[11] G. Goubau, C. Sharp and S. W Attwood “Investigation of a Surface-Wave Line for Long Distance Transmission” IRE Transactions on Microwave Theory and Techniques, pp 263-267, 1952.
[12] M. Friedman and Richard Fernsler, ‘Low-Loss RF Transport Over Long Distances’, IEEE Transaction on Microwave Theory and Techniques, Vol 49, No. 2, February 2001.

The foregoing patent and references reflect the current state of the art of which the present inventor is aware. Reference to, and discussion of, these materials is intended to aid in discharging Applicant's acknowledged duty of candor in disclosing information that may be relevant to the examination of claims to the present invention. However, it is respectfully submitted that none of the above-indicated references disclose, teach, suggest, show, or otherwise render obvious, either singly or when considered in combination, the invention described and claimed herein.

### BRIEF SUMMARY OF THE INVENTION

The system and method for launching surface waves over unconditioned lines of this invention provides a low loss transmission system, which utilizes a single uninsulated central conducting line segment without any special surface treatment or special enclosing dielectric and having launch devices mounted at each end. Furthermore this invention provides the use of conductors with circumference approaching and exceeding one wavelength at the propagating frequency. In combination, this invention allows the use of unconditioned and uninsulated conductors and in particular, existing overhead electric power lines which are available worldwide, for the economic and efficient transport of information.

Although the terms “surface wave” or “surface waves” are used herein, it should be understood that such description is used in order to facilitate understanding in accordance with previous thinking. The underlying theory and mechanism may be understood in terms other than these, including considering the wave which propagates as being similar to a wave which would propagate on an infinitely long antenna, perhaps coupled onto that antenna by a coaxial line. The existence of any such possible alternate representations should not be considered to in any way limit the invention described herein.

It is an object of this invention to provide a low loss surface wave transmission system, comprising elongated conductive means having no special surface conditioning or special covering and also comprising a means for exciting surface waves for transmission along the conductive means.

Another object of this invention is to provide a novel method of transmitting electromagnetic energy by the use of this surface wave transmission line.

A further object of this invention is to provide a transmission system operable in the frequency range above about 50 MHz and having extremely low attenuation over a very wide range of frequencies.

It is also an object of this invention to provide an effective and capable means of transporting information across a grid or network of existing power lines.

It is also an object of this invention to provide a transmission system which is economical to manufacture and maintain, of small size and light weight and physically flexible and adjustable.

A further object of this invention is to provide a surface wave transmission line which may be coupled to either a hollow wave guide or a coaxial cable, to receive energy from a source or feed transmitted energy to a translating device.

Another object of this invention is to provide a surface wave transmission line in conjunction with means for exciting surface waves for propagation along the line.

A specific object of this invention is to provide a surface wave transmission line in conjunction with a launching device for exciting surface waves for transmission along the line, wherein the launching device is of convenient dimension.

A further specific object of this invention is to provide a surface wave transmission line in conjunction with an electromagnetic horn, wherein movement of said line relative to the horn can be effected for adjusting the physical length of the line.

A further specific object of this invention is to provide a surface wave transmission line which can be used in conjunction with other surface wave transmission lines wherein the elongated conductor has its outer surface covered with a dielectric. Other specific forms of this transmission line include an elongated conductive means which has a physically irregular outer surface.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic side view in elevation of a system for launching surface waves over unconditioned power lines;

FIG. 2 shows a sample vector network analyzer measurement of a simple conical horn launch;

FIG. 3 shows a 2-6 GHz calculation of |S₂₁| and |S₁₁| for two 20 cm long tapered horns with 12 cm diameter mouths on an ideal 0.320″ (2 ACSR) diameter cylindrical conductor; and

FIG. 4 shows a representation of longitudinal and cross sectional electric field intensity of a simple linear taper launch.

### DETAILED DESCRIPTION OF THE INVENTION

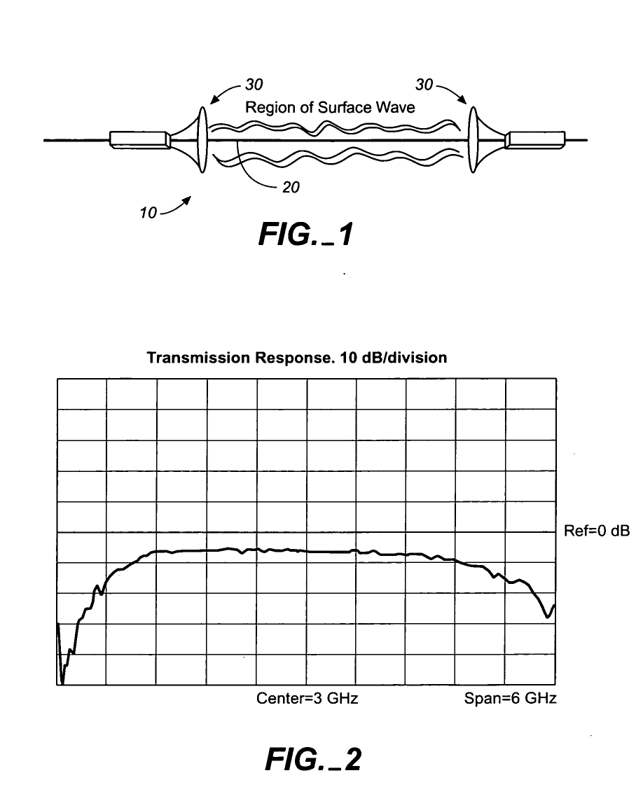

The present inventive system, a representative example of which is illustrated in FIG. 1, describes a low loss transmission system 10, which utilizes a single central conducting line segment 20 having no special surface treatment and no enclosing dielectric and also having one or two launch devices 30, each mounted at an end of line segment 20. This system differs from the invention of Goubau U.S. Pat. No. 2,685,068 in several respects:
(a) the conductor surface is without special preparation;
(b) the conductor surface may be either smooth or rough;
(c) the conductor surface is without dielectric sheath;
(d) the conductor may be circular or, within a range, have elliptical, rectangular or complex cross-section;
(e) the conductor may be comprised of two or more parallel conductors;
(f) the circumference of the conductor may approach and exceed a wavelength at the propagated frequency;
(g) the system supports propagation throughout the RF-Microwave region with a launching device of convenient dimensions;
(h) the relative velocity of propagation of the surface wave is at, or extremely close to, that of light.

Existing lines having no special conditioning, surface preparation or insulation may be used. This is essential to the utility of this invention when it is used in as part of a “last mile” information distribution system.

Existing lines which have a circumference which is significant compared to a wavelength may be used. The ability to convert from a coaxial (or waveguide) mode in the feeding transmission line to the surface wave mode on the line without generating higher order radiating modes is important because it allows common electric grid distribution line sizes to be used. It also allows very large electric grid transmission lines, some as large as 2″ in diameter, to be used to transport broadband information.

Good broadband performance can be achieved with conveniently sized launch devices. The preferred embodiment of this invention utilizes launch devices which are arranged to allow convenient installation on existing power lines as well as the capability to provide good performance over a large range of frequencies with a very conveniently sized device. For use on HV lines which require a minimum spacing between conductive structures contacting any line and other lines, small size can be a necessary attribute of the launch devices. An example of this type of launch is disclosed in U.S. patent application Ser. No. 10/732,080, entitled Method and Apparatus for Launching a Surfacewave onto a Single Conductor Transmission Line, by applicant herein, and hereby incorporated by reference herein, which discloses a launch having a longitudinal slot for installation and an exponentially tapered horn section to provide good broadband performance. This launch provides for good coupling to the surface wave mode over two bands, these bands and their width being affected primarily by the triaxial coupling section. Implementations using different coaxial coupling sections which use ferrite or similar resistive (lossy) decoupling elements rather than reactive line sections may be used to provide extremely broad band performance, from below 1 GHz to greater than 10 GHz, with no excluded ranges. Such a coaxial coupling section may use this material in much the same way that a broadband bias tee does to separate low frequency and high frequency signals. Ultra-wideband technology may require and utilize this type of coaxial adapter.

Alternate launch devices using two part “clam shell”, or more than two parts, which can be assembled around an existing line are also possible. A very great variety of existing power lines may be accommodated with a reasonable number of designs. The most line-specific portion of an implementation is generally the coaxial adapter section which can be made to accommodate a considerable, though not infinite, range of line diameters and types. Typical distribution lines range in diameter from approximately 0.2″ to 0.6″ and may be accommodated with a single, or two, different coaxial adapter implementations used in conjunction with a single exponentially tapered horn section.

Multiple surface wave line types, splices and impairments are accommodated. Existing lines which contain line splices and which may change type in the midst of a span are quite adequate. Although the discontinuities can produce some additional attenuation due to reflection and conversion from surface wave to radiating modes, provision is easily made for this through dynamically adjustable gain elements in accompanying amplifier circuits. This kind of dynamically adjustable gain is also useful to maintain a desired degree of system performance in the presence of external variables such as ice and bird loading of lines.

Intervening supports are also accommodated. Furthermore, lines having insulators and tap connections (as to a pole mounted transformer) may be used because the additional attenuation due to these impairments may be made up for by additional gain in the amplifying circuits. This allows a pair of launch devices to be used with a section of existing line which includes one or more intermediate power poles having insulators, taps and other features which can impair the transmission characteristics of the surface wave mode. The number of such impairments which can be allowed will depend upon the goal of a particular implementation, including desired maximum line levels, ingress and egress levels, desired system Carrier/Noise levels and other system parameters.

Use of this invention with the technology disclosed in copending U.S. patent application Ser. No. 10/250,625, entitled Method and Apparatus for Information Conveyance and Distribution, by applicant herein, and hereby incorporated by reference herein, allows economical combination with other media types. Combining this invention with other media types as shown in that reference can allow economical conversion to and from high tension lines. The insulating characteristics of fiber or free space can be used in conjunction with the simultaneous and bidirectional characteristics (full duplex) to easily “get on and off” the high voltage lines.

This invention may be combined with N-way power splitters and dividers as well as with multiple media types to allow the formation of more complex networks. For example, severe disruptions in a surface wave line, perhaps due to fuses or switches, may be bypassed with segments of optical fiber, wireless or coaxial cable, prior to resuming transport over surface wave segments. Intersections of lines may provide three, four or more way splitting of paths.

This invention can be used to provide simultaneous multiple streams of information transport for different protocols. For example, completely separate TDMA and CDMA information systems can be operated together, at the same time, without unwanted coupling or interference by using frequency domain separation.

Use of this invention can provide information distribution, transport, or both simultaneously. Both the distribution and transmission attributes of the nearly ubiquitous overhead power lines may be used to support the information transport being provided with this invention. Additionally, a single line can simultaneously provide periodic distribution or access, as often as every supporting pole, and at the same time provide “back haul” connection of information between two distant endpoints.

The inventive system enables common access by multiple distributed users. This invention may be used in a manner to allow multiple distributed users common access to the distribution and transport which it provides. This may be produced by deliberate mode conversion and radiation by multiple provided local antennas along the length of a surface wave line system. It may be provided by deliberately creating a degree of mode conversion within the launch devices to create a local point of access to the system. In this manner, users distributed along the length of the transmission system may fully share its capabilities. Such use may require protocols which provide for efficient sharing of the resource in situations where transmission by only one user or endpoint at a time is allowed.

The inventive system operates independently of line tensioning and sag. This system can operate efficiently over the range of tensions found on existing power lines which gravity causes to form a catenary curve. Normal variations in line tension and degree of curvature of typical power line installations have little effect on system performance.

The inventive system also accommodates dynamic gain. Amplifiers, filters and other electronics, including user access equipment, may be periodically placed along the length of a long run of power lines in order to make up for loss and to provide user access. This equipment may be powered from the line itself, through inductive coupling, capacitive coupling or direct transformer connections across two or more conductors. This equipment may also be solar powered as typical installation locations are on power line poles above surrounding shadowing and obstruction.

Measurements and Typical Characteristics

Two primary measurement methods are described here. Traditional two-port S parameter measurements may be made using two end launches, one at either end of a length of conductor. Also, one-port measurement made at a single launch on one end of a conductor section, terminated by a conductive mirror placed at right angles at the other end can be made. Through the use of time-gated error corrected measurements, performed with a calibrated microwave vector network analyzer, good agreement with the two port measurement method is possible. Additionally, time domain gating may be employed in order to identify and separate different reflection and transmission components due to the launches, line imperfections, obstructions and so forth. The one-port measurement technique allows convenient development of launch devices because a virtual identical pair of launches may be examined while fabricating or modifying only a single launch device.

A sample one-port vector network analyzer measurement of a simple conical horn launch is shown in FIG. 2. The increased attenuation visible near 0 and 6 GHz is due to the limited bandwidth of the particular coaxial coupler which was being used and does not represent characteristics of the surface wave transmission line or launch. Only moderate additional attenuation might be incurred by operating this same launch with a different coaxial adapter even at frequencies below 200 MHz where the launch is considerably smaller than one wavelength in diameter.

Conductor Types

A large variety of conductor types have been examined including copper, aluminum, and brass rods and tubes of a variety of diameters. In designing and optimizing launch devices for larger diameter power line conductors, conductors fabricated from standard copper water pipe have been examined. As reference texts on Goubau line already contain some information, beyond confirming utility, careful examination of lines with insulating dielectric materials has not been done. However, multiple sections of line type, including both unconditioned lines of this invention and insulated lines, as per Goubau's invention, have been cascaded and combined to verify the utility of the combination.

A list of some line types examined includes: #12 insulated stranded copper wire; #12 solid copper wire; ⅛″-¾″ thin wall brass tubing; ½″ copper water pipe (0.625′″ OD Schedule L); ¾″ copper water pipe (0.875″ OD); 1″ copper water pipe (1.125″ OD); 4 ACSR utility line; 2 ACSR utility line; and 4/0 ACSR utility line.

Line Losses With Typical Power Line as Conductor

In practice, overall loss on real lines is often affected by supporting structures, splices and discontinuities as much as by launch, conductor and radiation losses. Unless special calibration techniques or de-embedding are used, accurate measurement of line loss requires multiple measurements of different line lengths in order to eliminate launch loss from the result. In general, since line losses tend to be low, good measurement accuracy and repeatability is required for high accuracy.

Losses tend to be relatively independent of conductor diameter. As a typical example, |S₂₁| for 4-ACSR, 0.25″ diameter, or 2-ACSR, 0.32″ diameter, power line conductor is under 2.5 dB per 100 ft at 2.4 Ghz, when used with a 7″ exponentially tapered horn. Similar results apply to the measurement of #12 bare copper conductor (0.1″ diameter) when the same launch devices are used.

Impairments

The surface wave mode is best supported on a conductor which has no sudden turns, discontinuities or obstructions. As such, the normal method of suspending utility lines between insulated supporting poles and maintaining the region around the line clear of obstructions is fairly ideal. The catenary curve produced by gravity on typical overhead power line installations has little or no measurable effect on line loss. Variations in tension do not measurably affect line loss. Deviations from a series of straight in-line supports, where the deviation is on the order of 20 degrees, or less, cause additional attenuation which is small enough to be accommodated by dynamic gain amplification within the system.

Obstructions like insulators, splices, tangent line connections and so forth do cause both reflection and radiation (conversion of surface wave mode to a radiating mode). Typical additional transmission attenuation for these kinds of impairments is on the order of 6 dB and is generally quite constant as a function of frequency and therefor does not result in a great deal of group delay unflatness.

Computer Modeled Performance

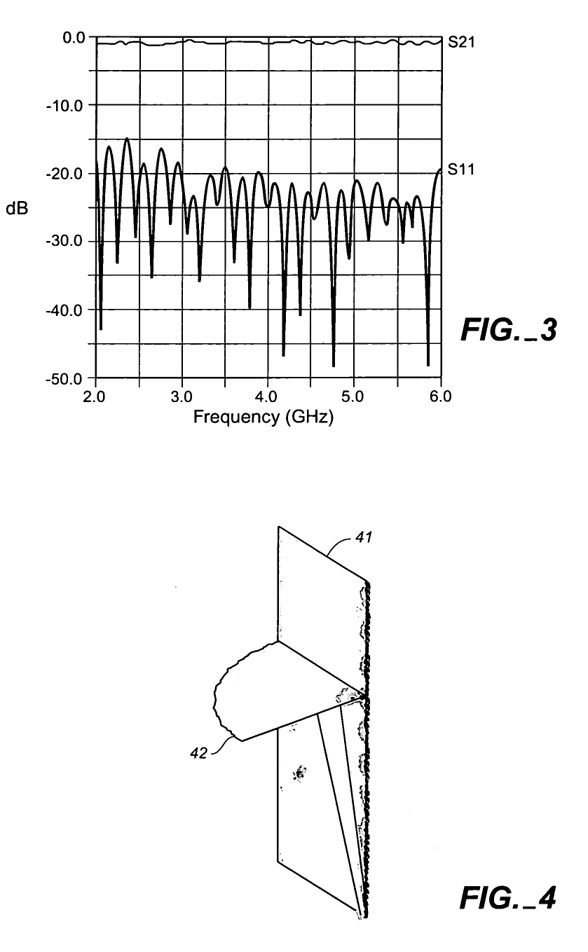

In the fifty years since the Goubau patent, which did include theoretical treatment of the surface wave, the potential of unconditioned lines has been unappreciated. It may be that the technical breadth presented actually discouraged others from considering the possibility for operation on unconditioned lines. As an alternative to providing a more correct closed form description of this invention, computer numerical finite element analysis has been performed of the conductors, launches and the other related structures necessary to implement a transmission system of this present invention. The computer effectively constructs a very large three dimensional mesh of points on a three dimensional model of the structure and solves Maxwell's equations at every node in order to produce predictive results. These results have shown good agreement with the measurements of fabricated structures and serve to confirm both the theory and practicality of the invention. Due to the extreme complexity of a detailed model of the launches and the significant wave length of conductor, the problem has been simplified by assuming a stepped, linear taper conical launch “horn” with only a few segments, rather than a more preferred exponentially tapered horn. Additionally only a total structure size of 10 to 20 wavelengths at the highest frequency has been considered. Even with these simplifications, a capable 2 GHz Pentium IV with 2 Gbytes of memory can require tens of hours of processing to produce a solution. FIG. 3 shows a 2-6 GHz calculation of |S₂₁| and |S₁₁| for two 20 cm long conical horns with 12 cm diameter mouths on an ideal 0.320″ (2 ACSR) diameter smooth, cylindrical conductor. This illustration shows that total losses are low over a considerable bandwidth. Better return loss and even lower launch loss is possible with more complex designs, but the extra complexity may be even more difficult to model with a computer.

A representation of longitudinal and cross sectional electric field intensity of a simple linear taper launch is shown in FIG. 4. The narrow portion of the launch is at the bottom and both longitudinal field 41 and cross-sectional field 42 are illustrated. In contrast with the teaching of Goubau regarding uninsulated conductors, the vast majority of the energy is contained in the center region and a practical surface wave transmission system with conveniently sized launches is demonstrably possible.

Accordingly, the invention may be characterized as a transmission system for electromagnetic energy of a predetermined frequency range above 50 MHz comprising elongated conductive means having an unconditioned surface without added dielectric, the energy being substantially contained in a cylindrical space which at a frequency within the frequency range extends radially from the conductive means to a predetermined distance therefrom, and the field being propagated axially in a direction substantially parallel to the conductive means coupled to a source of electromagnetic energy for forming a beam of wave energy of substantially radially symmetrical field configuration and of a diameter substantially equal to that of a cylindrical space containing the field of a frequency within the frequency range, and directed axially into the cylindrical space, the conductive means being coupled to the beam forming means to cause substantially continuous transition from the field of the beam to that of the conductive means, and means remote from the beam forming means and coupled to the conductive means for translating the energy propagated along the conductive means.

The transmission system also may be characterized as an open wave guide, an energy translation system, or an electromagnetic wave energy transmission system. Alternatively, the invention may be characterized as a method for launching a surface wave on an elongated conductor having an unconditioned surface and without added dielectric.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. A transmission system for electromagnetic energy of a predetermined frequency range above 50 MHz comprising elongated conductive means having an unconditioned surface without added dielectric, said energy being substantially contained in a cylindrical space which at a frequency within said frequency range extends radially from said conductive means to a predetermined distance therefrom, and said field being propagated axially in a direction substantially parallel to said conductive means coupled to a source of electromagnetic energy for forming a beam of wave energy of substantially radially symmetrical field configuration and of a diameter substantially equal to that of a cylindrical space containing the field of a frequency within said frequency range, and directed axially into said cylindrical space, said conductive means being coupled to said beam forming means to cause substantially continuous transition from the field of said beam to that of said conductive means, and means remote from said beam forming means and coupled to said conductive means for translating the energy propagated along said conductive means.

2. An open wave guide for transmitting electromagnetic energy of a predetermined frequency range above 50 MHz which comprises an elongated conductive means having an unconditioned surface without added dielectric, as to concentrate the field of the transmitted energy at said frequency range substantially in the space outside of said conductive means; said energy being substantially contained in a cylindrical space which at a frequency within said frequency range extends radially from said conductor surface to a predetermined distance therefrom, and said energy being propagated axially in a direction substantially parallel to said conductive means; and means for forming a beam of wave energy of substantially radially symmetrical field configuration and of a diameter substantially equal to that of a cylindrical space containing the field of a frequency within said frequency range and directed axially into said cylindrical space, said conductive means being coupled to said beam forming means to cause substantially continuous transition from the field of said beam to that of said conductive means.

3. An open wave guide system for a predetermined frequency range comprising a conductive wire line having an unconditioned surface without added dielectric, means for launching a beam of wave energy of substantially transverse magnetic mode symmetrically coaxial with said line, said wire line being coupled to said launching means to cause substantially continuous transition from the field of said beam to that of said wire line, to propagate said wave energy in non-radiating mode substantially in the space outside of said wire and in the direction of said wire, said energy being contained substantially within a predetermined cylindrical space coaxial and coextensive with said wire at a frequency within said frequency range and of a diameter substantially equal to that of said beam at a frequency within said frequency range.

4. An energy translation system for a predetermined frequency range comprising a source of electromagnetic wave energy and a receiver therefor, an elongated conductor having an unconditioned surface without added dielectric extending between said source and said receiver, to propagate wave energy substantially in the space outside of its conducting surface and in a direction substantially parallel to said conductor, said energy being confined at a frequency within said frequency range substantially within a predetermined cylindrical space coaxial and coextensive with said conductor; and separate means at the source and at the receiver respectively for coupling energy to said conductor, said coupling means including means for forming a beam of wave energy of substantially radially symmetrical field configuration and of a diameter substantially equal to that of a cylindrical space containing the field of a frequency within said frequency range and directed axially into said cylindrical space, said conductor being coupled to said beam forming means to cause substantially continuous transition from the field of said beam to that of said conductor.

5. In combination, an electromagnetic horn, an elongated conductor having an unconditioned surface without added dielectric extending coaxially with said horn, for propagating wave energy of a predetermined frequency range substantially in the space outside of said conductor and in a direction substantially parallel to said conductor, said energy being contained at a frequency within said frequency range substantially within a cylindrical space coaxial and coextensive with said conductor, and of a diameter substantially equal to that of said horn at a frequency within said frequency range, a coaxial line comprising inner and outer conductors, the outer conductor of said coaxial line being electrically connected to said horn for energy coupling thereto, and means forming an energy coupling between the inner conductor of said coaxial line and said elongated conductor.

6. In combination, a coaxial line having an unconditioned surface without added dielectric, an open wave guide comprising an elongated conductor means coupling said coaxial line and said open wave guide for launching a beam of wave energy of a predetermined frequency range symmetrically coaxial with said elongated conductor to propagate said wave energy in non-radiating mode substantially in the space outside of said conductor in a direction substantially parallel to said conductor; said energy being contained substantially in a cylindrical space coaxial and coextensive with said conductor at a frequency within said frequency range, and of a diameter substantially equal to that of said beam at a frequency within said frequency range; and said elongated conductor being coupled to said launching means to cause substantially continuous transition from the field of said beam to that of said conductive means.

7. In an electromagnetic wave energy transmission system, elongated conducting means having an unconditioned surface without added dielectric for transmitting substantially only a non-radiating mode of wave field energy of a predetermined frequency range substantially in the space outside of said conductor surface and in a direction substantially parallel to said elongated conducting means, said energy being contained substantially within a cylindrical space coaxial and coextensive with said elongated conducting means at a frequency within said frequency range, and means for forming a beam of wave field energy of substantially radially symmetrical field configuration of a diameter substantially equal to that of a cylindrical space containing the field of a frequency within said frequency range and directed axially into said cylindrical space, the interface of the two wave energy fields being of the order of wave length dimension: and said conducting means being coupled to said beam forming means to cause substantially continuous transition from the field of said beam to that of said conductive means.

8. In an electromagnetic wave energy transmission system, means for supplying concentrated wave energy of a predetermined frequency range, elongated conducting means having an unconditioned surface without added dielectric for transmitting substantially only a non-radiating mode of wave energy substantially in the space outside of the said conductor surface and in a direction substantially parallel to said elongated conducting means, said energy being contained substantially within a cylindrical space coaxial and coextensive with said elongated conducting means at a frequency within said frequency range: and means coupled to said supplying means for forming said concentrated wave energy into a beam of wave energy of substantially radially symmetrical field configuration of a diameter substantially equal to that of a cylindrical space containing the field of a frequency within said frequency range and coaxially directed into said cylindrical space, said conducting means being coupled to said beam forming means to cause substantially continuous transition from the field of said beam to that of said conductive means.

9. A transmission system for electromagnetic energy of a predetermined frequency range above 50 MHz comprising elongated conductive means having an unconditioned surface without added dielectric, and confining the transmitted energy at said frequency range substantially in the space outside of its conductor surface and within a cylindrical space which at a frequency within said frequency range extends radially symmetrically from said surface to a predetermined distance therefrom, said field being propagated axially in a direction substantially parallel to said conductive means, means coupled to a source of electromagnetic energy for forming a beam of wave energy of substantially radially symmetrical field configuration of a diameter substantially equal to that of a cylindrical space containing the field of a frequency within said frequency range and directed axially into said cylindrical space, means for coupling said beam forming means to said conductive means including a conductor axially disposed with respect to said beam, and means remote from said beam forming means and coupled to said conductive means for translating the energy propagated along said elongated conductive means.

10. A method for launching a surface wave on a line, said method comprising the steps of:
providing an elongated conductor having an unconditioned surface and without added dielectric;
generating energy substantially contained in a cylindrical space at a frequency within a desired frequency range and extending radially from the conductor to a predetermined distance therefrom;
propagating a field axially in a direction substantially parallel to the conductor to form a beam of wave energy of substantially radially symmetrical field configuration and of a diameter substantially equal to that of a cylindrical space containing the field of a frequency within the frequency range, and directed axially into the cylindrical space; and
translating the energy propagated along the conductor at a remote location.
